(19) United States
(12) Patent Application Publication
(10) Pub. No.: US 2012/0282003 A1
(43) Pub. Date: Nov. 8, 2012

(54) FUSER MEMBER

(75) Inventors: Kurt I. Halfyard, Mississauga (CA); Carolyn P. Moorlag, Mississauga (CA); David J. Gervasi, Pittsford, NY (US); Nicoleta D. Mihai, Oakville (CA); Guiqin Song, Milton (CA); Nan-Xing Hu, Oakville (CA); T. Brian McAneney, Burlington (CA)

(73) Assignee: XEROX CORPORATION, Norwalk, CT (US)

(21) Appl. No.: 13/102,192

(22) Filed: May 6, 2011

(51) Int. Cl. G03G 15/20; B32B 27/00

(52) U.S. Cl. 399/333; 428/421

(57) ABSTRACT

The present teachings provide a fuser system member including a substrate and a topcoat layer disposed over the substrate. The topcoat layer comprises a fluoroelastomer cross-linked with amino silane wherein the topcoat is substantially free of copper oxide. A mercapto-functionalized oil is disposed on the topcoat layer.

### BACKGROUND

1. Field of Use

This disclosure is generally directed to fuser members useful in electrophotographic imaging apparatuses, including digital, image on image, and the like. In addition, the fuser member described herein can also be used in a transfix apparatus in a solid ink jet printing machine.

2. Background

In the electrophotographic printing process, a toner image can be fixed or fused upon a support (e.g., a paper sheet) using a fuser roller. Conventional fusing technologies apply release agents/fuser oils to the fuser roller during the fusing operation in order to maintain good release properties of the fuser roller. For example, oil fusing technologies have been used for all high speed products in the entry production and production color market.

Post finishing applications, such as lamination, book binding and magnetic ink character recognition (MICR) in the banking industry prints have been hindered by residual oil on the substrate. Specifically amino functionalized polydimethylsiloxane (PDMS) from the fuser roll can transfer to the substrate.

It would be desirable to have a fuser oil that does not negatively interact with post finishing applications of substrates.

In U.S. Pub. 2009/0233085, the use of nano-sized copper oxide in the fuser surface is described which mitigates certain post finishing problems. However, the use of nano-sized particles can negatively impact manufacturing cost and present environmental issues related to the handling of nano-sized particles.

### SUMMARY

According to an embodiment, there is provided a fuser member comprising a substrate and a topcoat layer disposed over the substrate. The topcoat layer comprises a fluoroelastomer cross-linked with amino silane, wherein the topcoat layer is substantially free of copper oxide. A mercapto-functionalized oil is disposed on the topcoat layer.

According to another embodiment there is provided a fuser member comprising a substrate, a resilient layer disposed on the substrate and a topcoat layer disposed on the resilient layer. The topcoat layer comprises a fluoroelastomer cross-linked with amino silane, wherein the topcoat layer is substantially free of copper oxide. A mercapto-functionalized oil is disposed on the topcoat layer.

According to another embodiment there is provided an image rendering device comprising: an image applying component for applying an image to a copy substrate; and a fusing apparatus which receives the copy substrate with the applied image from the image applying component and fixes the applied image more permanently to the copy substrate. The fusing apparatus comprises a fusing member and a pressure member which define a nip therebetween for receiving the copy substrate therethrough. The fuser member comprises a substrate and a topcoat layer disposed on the substrate comprising a fluoroelastomer cross-linked with amino silane, wherein the topcoat layer is substantially free of copper oxide. A mercapto-functionalized oil is disposed on the topcoat layer.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 depicts an exemplary fusing member having a cylindrical substrate in accordance with the present teachings.

FIG. 2 depicts an exemplary fusing member having a belt substrate in accordance with the present teachings.

FIGS. 3A-3B depicts exemplary fusing configurations using the fuser rollers shown in FIG. 1 in accordance with the present teachings.

FIGS. 4A-4B depicts another exemplary fusing configurations using the fuser belt shown in FIG. 2 in accordance with the present teachings.

FIG. 5 depicts an exemplary fuser configuration using a transfix apparatus.

FIG. 6 depicts fourier transfer infrared spectroscopy (FTIR) surface chemistry of various release agents.

FIG. 7 depicts print gloss of substrates for various release agents.

FIG. 8 shows roll surface contamination as measured by FTIR of various release agents.

It should be noted that some details of the figures have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Illustrations with respect to one or more implementations, alterations and/or modifications can be made to the illustrated examples without departing from the spirit and scope of the appended claims. In addition, while a particular feature may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values.

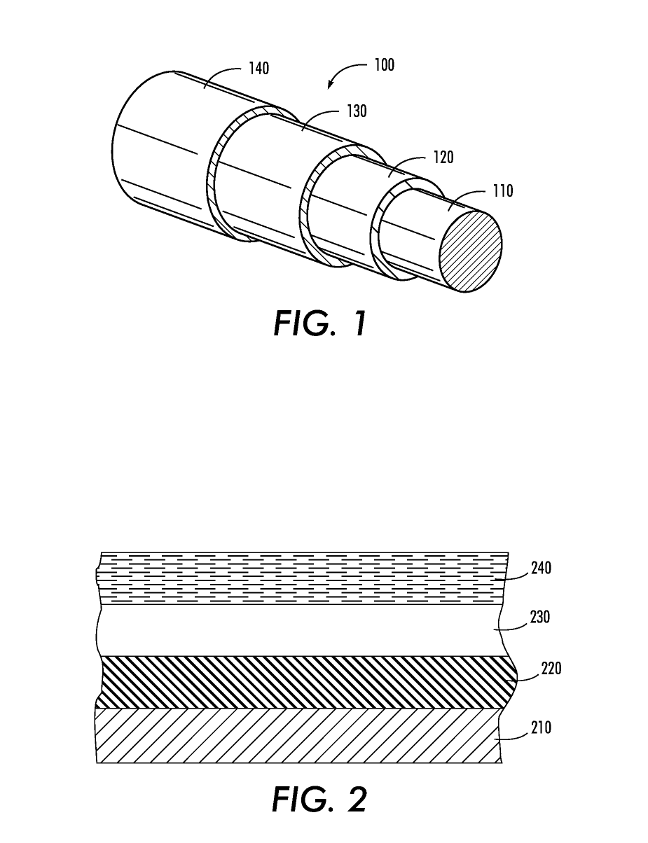

In various embodiments, the fusing or fixing member can include, for example, a substrate, with one or more functional layers formed thereon. The substrate can be formed in various shapes, e.g., a cylinder (e.g., a cylinder tube), a cylindrical drum, a belt, or a film, using suitable materials that are non-conductive or conductive depending on a specific configuration, for example, as shown in FIGS. 1 and 2.

Specifically, FIG. 1 depicts an exemplary fixing or fusing member 100 having a cylindrical substrate 110 and FIG. 2 depicts another exemplary fixing or fusing member 200 having a belt substrate 210 in accordance with the present teachings. It should be readily apparent to one of ordinary skill in the art that the fixing or fusing member 100 depicted in FIG. 1 and the fixing or fusing member 200 depicted in FIG. 2 represent generalized schematic illustrations and that other layers/substrates can be added or existing layers/substrates can be removed or modified.

In FIG. 1 the exemplary fixing member 100 can be a fuser roller having a cylindrical substrate 110 with one or more functional layers 120 and an outer layer 130 formed thereon. In various embodiments, the cylindrical substrate 110 can take the form of a cylindrical tube, e.g., having a hollow structure including a heating lamp therein, or a solid cylindrical shaft. In FIG. 2, the exemplary fixing member 200 can include a belt substrate 210 with one or more functional layers, e.g., 220 and an outer surface 230 formed thereon. The belt substrate 210 and the cylindrical substrate 110 can be formed from, for example, polymeric materials (e.g., polyimide, polyaramide, polyether ether ketone, polyetherimide, polyphthalamide, polyamide-imide, polyketone, polyphenylene sulfide, fluoropolyimides or fluoropolyurethanes), metal materials (e.g., aluminum or stainless steel) to maintain rigidity and structural integrity as known to one of ordinary skill in the art. Positioned on the outer surface 130 is a liquid release agent 140. For the belt configuration in FIG. 2, the liquid release agent is identified as 240.

Examples of functional layers 120 and 220 include fluorosilicones, silicone rubbers such as room temperature vulcanization (RTV) silicone rubbers, high temperature vulcanization (HTV) silicone rubbers, and low temperature vulcanization (LTV) silicone rubbers. These rubbers are known and readily available commercially, such as SILASTIC® 735 black RTV and SILASTIC® 732 RTV, both from Dow Corning; 106 RTV Silicone Rubber and 90 RTV Silicone Rubber, both from General Electric; and JCR6115CLEAR HTV and SE4705U HTV silicone rubbers from Dow Corning Toray Silicones. Other suitable silicone materials include the siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; and the like. Another specific example is Dow Corning Sylgard 182. Commercially available LSR rubbers include Dow Corning Q3-6395, Q3-6396, SILASTIC® 590 LSR, SILASTIC® 591 LSR, SILASTIC® 595 LSR, SILASTIC® 596 LSR, and SILASTIC® 598 LSR from Dow Corning. The functional layers provide elasticity and can be mixed with inorganic particles, for example SiC or Al₂O₃, as required.

For a roller configuration, the thickness of the functional layer can be from about 0.02 mm to about 10 mm, or from about 1 mm to about 8 mm, or from about 2 mm to about 7 mm. For a belt configuration, the functional layer can be from about 25 microns up to about 2 mm, or from 40 microns to about 1.5 mm, or from 50 microns to about 1 mm.

An exemplary embodiment of a release layer 130 or 230 includes a fluoroelastomer and an amino silane as a curative agent. Fluoroelastomers are from the class of 1) copolymers of two of vinylidenefluoride, hexafluoropropylene, and tetrafluoroethylene such as those known commercially as VITON A®; 2) terpolymers of vinylidenefluoride, hexafluoropropylene, and tetrafluoroethylene known commercially as VITON B®; and 3) tetrapolymers of vinylidenefluoride, hexafluoropropylene, tetrafluoroethylene, and cure site monomer known commercially as VITON GH® or VITON GF®. These fluoroelastomers are known commercially under various designations such as those listed above, along with, VITON E®, VITON E 60C®, VITON E430®, VITON 910®, ; and VITON ETP®. The VITON® designation is a trademark of E.I. DuPont de Nemours, Inc. The cure site monomer can be 4-bromoperfluorobutene-1,1,1-dihydro-4-bromoperfluorobutene-1,3-bromoperfluoropropene-1,1,1-dihydro-3-bromoperfluoropropene-1, or any other suitable, known cure site monomer, such as those commercially available from DuPont. Other commercially available fluoropolymers include FLUOREL 2170®, FLUOREL 2174®, FLUOREL 2176®, FLUOREL 2177® and FLUOREL LVS 76®, FLUOREL® being a registered trademark of 3M Company. Additional commercially available materials include AFLAS™ a poly(propylene-tetrafluoroethylene), and FLUOREL II® (LII900) a poly(propylene-tetrafluoroethylenevinylidenefluoride), both also available from 3M Company, as well as the Tecnoflons identified as FOR-60KIR®, FOR-LHF®, NM® FOR-THF®, FOR-TFS®, TH®, NH®, P757®, TNS®, T439®, PL958®, BR9151® and TN505®, available from Ausimont.

The fluoroelastomers VITON GH® and VITON. GF® have relatively low amounts of vinylidenefluoride. The VITON GF® and VITON GH® have about 35 weight percent of vinylidenefluoride, about 34 weight percent of hexafluoropropylene, and about 29 weight percent of tetrafluoroethylene, with about 2 weight percent cure site monomer.

The amino silane as a curative agent is present, in embodiments, in an effective amount of, for example, from about 0.5 to about 10 percent (weight percent) based on the weight of fluoroelastomer. In embodiments, the amino silane is present in an amount of from about 1 to about 5 percent. In embodiments, the amino silane is present in an amount of from about 1 to about 2 percent based on the weight of fluoroelastomer.

The amino silane is of the general formula NH₂(CH₂)ₙNH₂(CH₂)ₘSi((OR)ₜ(R′)_{w}) wherein n and m are numbers from about 1 to about 20, or from about 2 to about 6; t+w=3; R and R′ are the same or different and are an aliphatic group of from about 1 to about 20 carbon atoms, such as methyl, ethyl, propyl, butyl, and the like, or an aromatic group of from about 6 to about 18 carbons, for example, benzene, tolyl, xylyl, and the like. Examples of amino silanes include 4-aminobutyldimethyl methoxysilane, 4-aminobutyl triethoxysilane, (aminoethylaminomethyl)phenyl triethoxysilane, N-(2-aminoethyl)-3-aminopropylmethyl dimethoxysilane, N-(2-aminoethyl)-3-aminopropyl trimethoxysilane, N-(2-aminoethyl)-3-aminopropyl tris(2-ethyl-hexoxy)silane, N-(6-aminohexyl)aminopropyl-trimethoxysilane, 3-(1-aminopropoxy)-3,3-dimethyl-1-propenyl-trimethoxysilane, 3-aminopropyl tris(methoxyethoxyethoxy)-silane, 3-aminopropyldimethyl ethoxysilane, 3-aminopropylmethyl diethoxysilane, 3-aminopropyl diisopropylethoxysilane, 3-aminopropyl triethoxysilane, 3-aminopropyl trimethoxysilane, or 3-aminopropyltris(trimethylsiloxy)silane. In embodiments amino silanes are AO700 (N-(2-aminoethyl)-3-aminopropyl trimethoxysilane), 3-(N-styrylmethyl-2-aminoethyl aminopropyl)trimethoxy silane, sold in its hydrochloride form, and (aminoethyl aminomethyl)phenyl trimethoxy silane all manufactured by Huls of America, Inc. The release layer 130 or 230 is substantially free of copper oxide.

In U.S. Pub. 2009/0233085, the use of nano-sized copper oxide in the fuser surface is described which mitigates certain post finishing problems. However, the use of nano-sized particles increases manufacturing cost by adding a raw material. The disclosure described herein eliminates the requirement of copper oxide particles. Providing a fluorelastomer topcoat cross linked with amino silane layer that is substantially free of copper oxide eliminates a material from the topcoat. Substantially free in the context of the topcoat layer means less than about 0.01 weight percent of copper oxide in the topcoat layer, or less than 0.005 weight percent of copper oxide in the topcoat layer, or less than 0.001 weight percent copper oxide in the topcoat layer.

For the fuser member 200, the thickness of the outer surface layer or release layer 230 can be from about 10 microns to about 100 microns, or from about 20 microns to about 80 microns, or from about 40 microns to about 60 microns.

Additives and additional conductive or non-conductive fillers may be present in the intermediate layer substrate layers 110 and 210, the intermediate layers 120 and 220 and the release layers 130 and 230. In various embodiments, other filler materials or additives including, for example, inorganic particles, can be used for the coating composition and the subsequently formed surface layer. Conductive fillers used herein may include carbon blacks such as carbon black, graphite, fullerene, acetylene black, fluorinated carbon black, and the like; carbon nanotubes; metal oxides and doped metal oxides, such as tin oxide, antimony dioxide, antimony-doped tin oxide, titanium dioxide, indium oxide, zinc oxide, indium oxide, indium-doped tin trioxide, and the like; and mixtures thereof. Certain polymers such as polyanilines, polythiophenes, polyacetylene, poly(p-phenylene vinylene), poly(p-phenylene sulfide), pyrroles, polyindole, polypyrene, polycarbazole, polyazulene, polyazepine, poly(fluorine), polynaphthalene, salts of organic sulfonic acid, esters of phosphoric acid, esters of fatty acids, ammonium or phosphonium salts and mixtures thereof can be used as conductive fillers. The fillers are present in the topcoat or release layer in an amount of from about 0.1 weight percent to about 50 weight percent based on the total weight of the release layer or outer surface layer. In embodiments, the fillers are present in an amount of from about 0.5 weight percent to about 20 weight percent or from about 1 weight percent to about 10 weight percent based on the total weight of the topcoat layer In various embodiments, other additives known to one of ordinary skill in the art can also be included to form the disclosed composite materials.

Optionally, any known and available suitable adhesive layer may be positioned between the outer layer or outer surface, the functional layer and the substrate. The adhesive layer can be coated on the substrate, or on the outer layer, to a thickness of from about 2 nanometers to about 10,000 nanometers, or from about 2 nanometers to about 1,000 nanometers, or from about 2 nanometers to about 5000 nanometers. The adhesive can be coated by any suitable known technique, including spray coating or wiping.

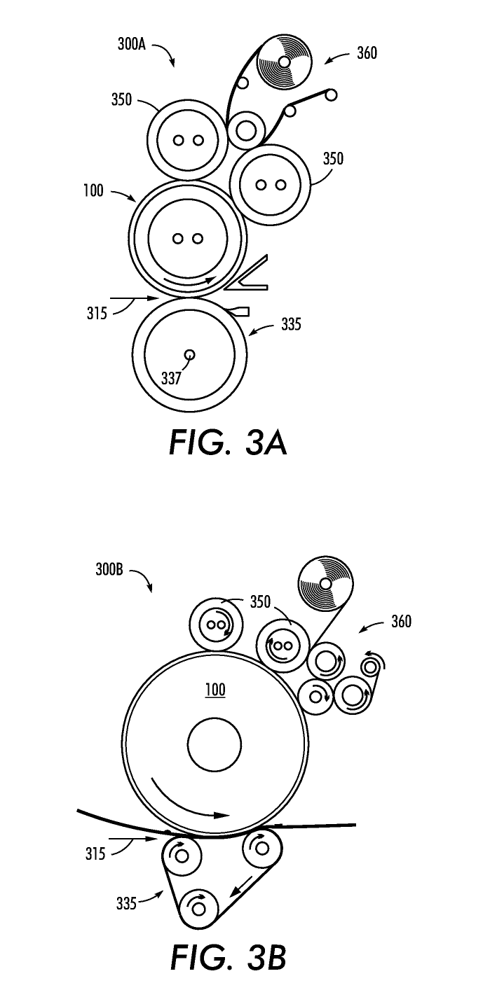

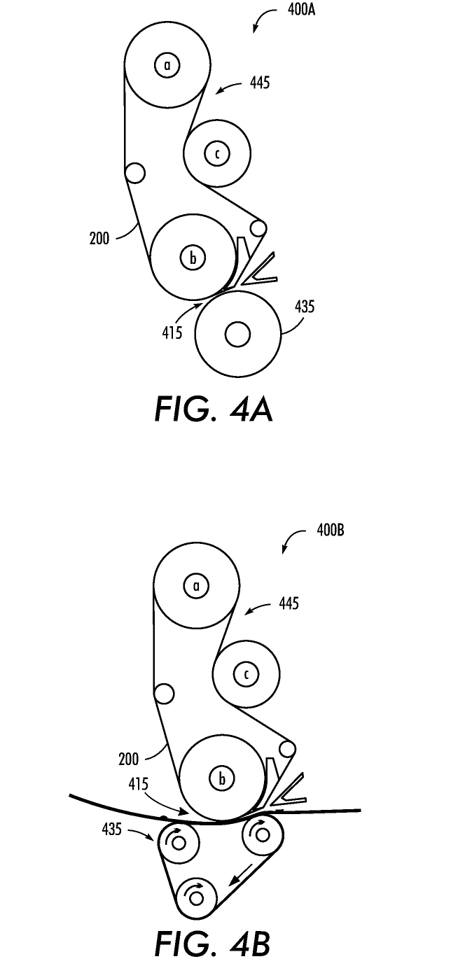

FIGS. 3A-4B and FIGS. 4A-4B depict exemplary fusing configurations for the fusing process in accordance with the present teachings. It should be readily apparent to one of ordinary skill in the art that the fusing configurations 300A-B depicted in FIGS. 3A-3B and the fusing configurations 400A-B depicted in FIGS. 4A-4B represent generalized schematic illustrations and that other members/layers/substrates/configurations can be added or existing members/layers/substrates/configurations can be removed or modified. Although an electrophotographic printer is described herein, the disclosed apparatus and method can be applied to other printing technologies. Examples include offset printing and inkjet and solid transfix machines.

FIGS. 3A-3B depict the fusing configurations 300A-B using a fuser roller 100 shown in FIG. 1 in accordance with the present teachings. The configurations 300A-B can include a fuser roller 100 (i.e., 100 of FIG. 1) that forms a fuser nip with a pressure applying mechanism 335, such as a pressure roller in FIG. 3A or a pressure belt in FIG. 3B, for an image supporting material 315. In various embodiments, the pressure applying mechanism 335 can be used in combination with a heat lamp 337 to provide both the pressure and heat for the fusing process of the toner particles on the image supporting material 315. In addition, the configurations 300A-B can include one or more external heat roller 350 along with, e.g., a cleaning web 360, as shown in FIG. 3A and FIG. 3B.

FIGS. 4A-4B depict fusing configurations 400A-B using a fuser belt shown in FIG. 2 in accordance with the present teachings. The configurations 400A-B can include a fuser belt 200 (i.e., 200 of FIG. 2) that forms a fuser nip with a pressure applying mechanism 435, such as a pressure roller in FIG. 4A or a pressure belt in FIG. 4B, for a media substrate 415. In various embodiments, the pressure applying mechanism 435 can be used in a combination with a heat lamp to provide both the pressure and heat for the fusing process of the toner particles on the media substrate 415. In addition, the configurations 400A-B can include a mechanical system 445 to move the fuser belt 200 and thus fusing the toner particles and forming images on the media substrate 415. The mechanical system 445 can include one or more rollers 445a-c, which can also be used as heat rollers when needed.

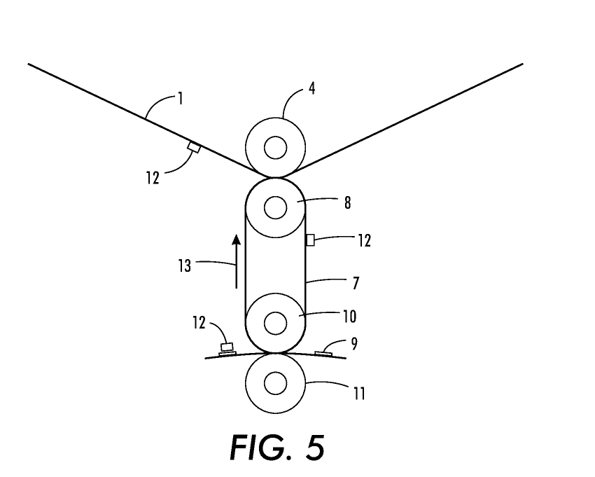

FIG. 5 demonstrates a view of an embodiment of a transfix member 7 which may be in the form of a belt, sheet, film, or like form. The transfix member 7 is constructed similarly to the fuser belt 200 described above. The developed image 12 positioned on intermediate transfer member 1 is brought into contact with and transferred to transfix member 7 via rollers 4 and 8. Roller 4 and/or roller 8 may or may not have heat associated therewith. Transfix member 7 proceeds in the direction of arrow 13. The developed image is transferred and fused to a copy substrate 9 as copy substrate 9 is advanced between rollers 10 and 11. Rollers 10 and/or 11 may or may not have heat associated therewith.

When using a fluoroelastomer as the outer surface of a fuser member, a liquid 140 (FIG. 1) or 240 (FIG. 2), also referred to as a release agent, is applied to aid in transfer of the toner to the substrate. iGen Viton (fluoroelastomer cured with an amino silane) as the fuser top-coat 130, 230 over a silicone intermediate layer 120, 220 was designed specifically to interact with amino-functionalized polydimethylsiloxane (PDMS) oil to form a better barrier on the fuser roller. A fraction of this release agent transfers to the substrate (i.e. customer print) surface during the oil-layer-split release-event of toner and sheet where the amine groups can bind with the surface of the sheet and linger to the point where the low surface energy of the surface oil causes issues. Typically, the nominal release agent rate of transfer to the substrate is from about of 8-13 mg/letter-sized-sheet on coated stock such as Digital Colour Elite Gloss. Since a 1 mg/letter-sized-sheet transfer rate is not attainable with the iGen Viton (fluoroelastomer cured with an amino silane), a solution to the problem is found elsewhere. While the amount of release agent 140, 240 transferred to the sheet can vary with substrate, if more than 1 mg/letter-sized-sheet transfer rate is exceeded, post-finishing performance is degraded. The amine groups in amino-functionalized PDMS bond with the cellulose or other substrate paper materials to hinder post-finishing.

The presence of an aminosilane curing agent, such as AO700, promotes a chemical event or events enabling wetting of the fluoroelastomeric surface. Non-bonding interactions occur at the surface. As mentioned previously, the amino silane is of the general formula NH₂(CH₂)ₙNH₂(CH₂)ₘSi((OR)ₜ(R′)_{w}) wherein n and m are numbers from about 1 to about 20, or from about 2 to about 6; t+w=3; R and R′ are the same or different and are an aliphatic group of from about 1 to about 20 carbon atoms, such as methyl, ethyl, propyl, butyl, and the like, or an aromatic group of from about 6 to about 18 carbons, for example, benzene, tolyl, xylyl, and the like.

Using an organo functionality in the release oil, such as the mercapto-functionalized PDMS oil can alleviate this problem.

Shown in Structure 1 below is a PDMS release oil having amino functionality. This is referred to as fuser fluid in the examples.

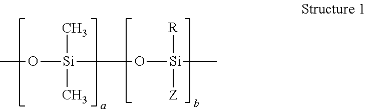

wherein R is CH₃, an alkyl group or aryl group, Z is amino propyl (CH₂CH₂CH₂NH₂), and the ratio of a:b is from about 1:1 to about 2000:1.

Shown in Structure 2 below is a mercapto-functionalized PDMS release oil. This is referred to as fuser agent in the Examples.

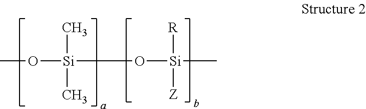

wherein R is CH₃, and alkyl group or and aryl group, Z is (CH₂)ₙSH where n is from about 1 to about 20, or from about 2 to about 10 or from about 3 to about 5, the ratio of a:b is from about 1:1 to about 2000:1.
Scheme 1 shows a proposed mechanism for thiol groups of mercapto fluid binding to fluoroelastomer chains cured with an aminosilane (Viton).

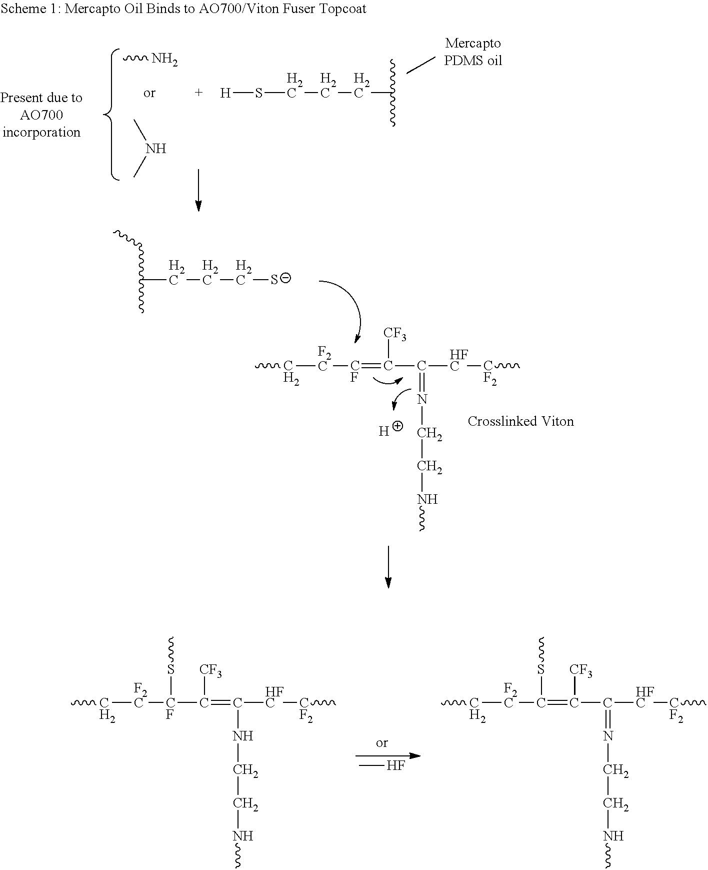

The presence of residual primary and secondary amines from aminosilane at the fluoroelastomer topcoat surface, at high temperature, can result in deprotonation of the thiol to yield the basic thiolate group. The thiolate undergoes nucleophilic addition of residual double bonded positions on the Viton chains, where 1,4 nucleophilic addition of the conjugate formed by amino crosslinking is especially favorable. In this system, the amino groups of the aminosilane coupler act as both the base to produce a thiolate, and its presence via crosslinking as a conjugate along the fluoroelastomer chain promotes reaction at the surface. Mercapto fluid and aminosilane function together in the system to enable wetting.

Switching the release oil for a fuser topcoat of fluoroelastomer cured with an aminosilane results in a change in chemistry that leads to a difference in binding the thiol group on the mercapto fluid to allow a similar barrier to form on the fuser surface. This provides adequate release of the toner and prevents rapid contamination build up of the release oil, which can cause release failure and other failure modes that cause short fuser roller life to customers. The result is significantly improved adhesion in a book-binding test using a standard glue, such as EVA based hot melt adhesives, US661, Dowell 983, EXP. A, Bourg 3002, Reynolds 025 and 029, Henkel US-703, as the substrate lacks amino groups from the release oil.

Specific embodiments will now be described in detail. These examples are intended to be illustrative, and not limited to the materials, conditions, or process parameters set forth in these embodiments. All parts are percentages by solid weight unless otherwise indicated.

### Examples

Tests were conducted to verify the use of organo-functionalized siloxane release oils used with fluoroelastomeric topcoats cured with an amino silane. An exemplary bisphenol curing agent can include VITON® Curative No. 50 (VC-50) available from E. I. du Pont de Nemours, Inc. Curative VC-50 can contain Bisphenol-AF as a cross-linker and diphenylbenzylphosphonium chloride as an accelerator. Bisphenol-AF is also known as 4,4′-(hexafluoroisopropylidene)diphenol. VC-50 cured roller topcoats fail after less than 1,000 sheets through the fuser from lack of release. In the case of AO700 cured roller topcoats (fluoroelastomer cured with amino silane), release was excellent all the way to the end of a 25,000 sheet test running different color stripes at various toner mass (monolayer C,M,Y,K and trilayer process black). Release agents or oil transferred to sheet was slightly lower for the mercapto oil, although no streaking or other oil-caused print defects were observed in this test.

Amino-functionalized oil prevents the glue from sticking to the sheet, resulting in a fiber-tear rating of 0. With a similar amount of mercapto-functionalized oil (Table 1) transferred to the substrate (Productolith C1S Cover, uncoated side) the amount of fiber tear is markedly improved. (Table 2)

TABLE 1
Oil-Release (iGen specification is 8-13 mg/letter-sized-sheet)

| | Average Oil-On-Copy |
|---|---|
| Top-Coat | (mg/sheet) |
| VC50 | 8 |
| AO700 | 5.7 |

TABLE 2
Fiber Tear (100% is best, 0 is no adhesion)

| Top-Coat | Fiber Tear Test |
|---|---|
| VC50 | 0 |
| AO700 | 73 |

The following FTIR data (Table 3) is indicative of the surface reactivity of the AO700-crosslinked fluoroelastomer composition with a variety of solutions. The following release agents were reacted with the fluoroelastomer-aminosilane cured topcoat material described herein.

TABLE 3
Solution treatments for AO700 topcoat formulation

| | Solution Treatment | Description |
|---|---|---|
| A | decanethiol, 0.2M in hexane | Mercapto-functional alkane |
| B | decylamine, 0.2M in hexane | Amine-functional alkane |
| C | Fuser Agent (SH) | Mercapto-functional Silicone |
| D | Fuser Fluid II (NH) | Amine-functional silicone |
| E | PDMS non-f, AK50 | non-functional silicone |
| F | hexane | hydrocarbon solvent control |

These solution treatments are either actual polydimethylsiloxane release agents used in electrophotographic printing systems, or analog release agents thereof. The release agents were applied to the fuser topcoat surface, heated and rinsed with hexane. The measurements were made with ATR (Attenuated Total Reflectance) FT-IR. The asymmetric CH₂ stretch ratio of 2926 cm⁻¹/1396 cm⁻¹ represents the relative amount of attached alkane after the treatment, while the asymmetric CH₃ stretch ratio of 2926 cm⁻¹/1396 cm⁻¹ represents the relative amount of PDMS attached after the treatment.

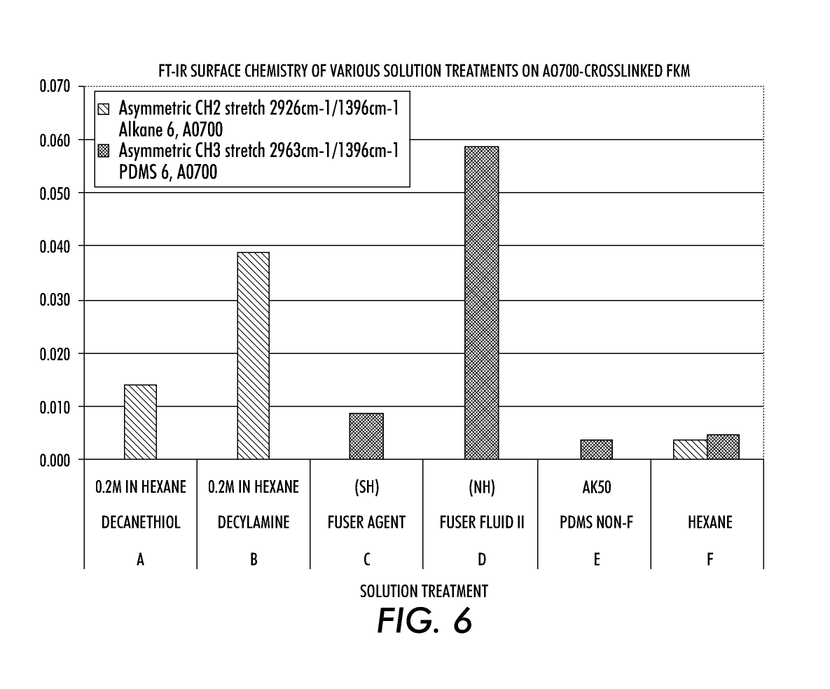

The data in FIG. 6 below for solution treatments E and F demonstrate a baseline control level of either alkane or PDMS material on the surface of the topcoat material after treatment. While the higher peak intensity ratio for solutions B and D are expected, as it is well-known in the art that amine functional fluids will chemically react with the fuser topcoat surface. The moderate levels of solutions A and C are at least double that of the control fluids, E and F. While some of the variation could be related to a viscosity effect of the various solutions it is postulated that the mercapto-functional solution treatments are reacting with the fluoroelastomer aminosilane cured topcoat material via the proposed mechanism described in Scheme 1.

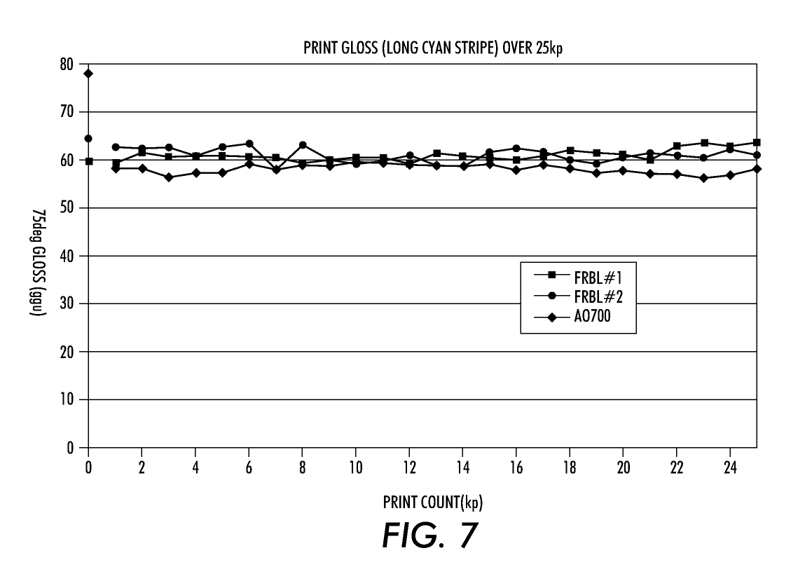

Print gloss was unaffected; samples fused with Amino Oil on VC50 fuser rollers were statistically similar to mercapto oil on an AO700 Roll as shown in FIG. 7. FRDL#1 and FRBL#2 are VC50 Control iGen3 Rollers.

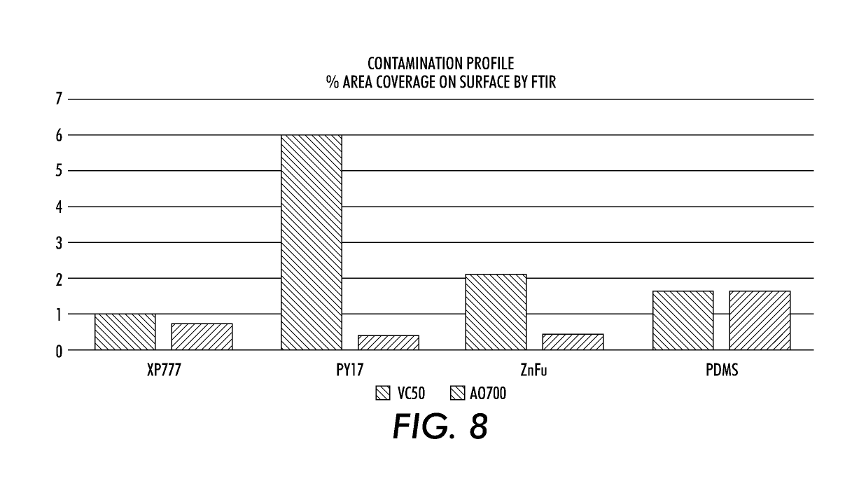

Fuser contamination of the usual contaminants, PDMS gel, XP777 resin, PY-17 Pigment and Zinc Fumarate for the AO700/mercapto-oil roller after 25 kp was similar to or less than the VC50/Amino-oil roller. (FIG. 8). FIG. 8 shows that switching to radically different oil chemistry does not increase undesirable contamination elements (PDMS=gelled polydimethyl siloxane, XP777 is toner resin, PY-17 is yellow pigment from the yellow toner which can often stain the fuser roller, and Zinc Fumarate is a contaminate resulting from undesirable chemistry between toner-additives and toner residual material.

It will be appreciated that variants of the above-disclosed and other features and functions or alternatives thereof may be combined into other different systems or applications. Various presently unforeseen or unanticipated alternatives, modifications, variations, or improvements therein may be subsequently made by those skilled in the art, which are also encompassed by the following claims.

What is claimed is:

1. A fuser system member comprising:
a substrate;
a topcoat layer disposed over the substrate comprising a fluoroelastomer cross-linked with amino silane wherein the topcoat layer is substantially free of copper oxide; and
a mercapto-functionalized oil disposed on the topcoat layer.

2. The fuser system member of claim 1 wherein the fluoroelastomer is a material selected form the group consisting of copolymers of two of vinylidenefluoride, hexafluoropropylene, and tetrafluoroethylene; terpolymers of vinylidenefluoride, hexafluoropropylene, and tetrafluoroethylene; and tetrapolymers of vinylidenefluoride, hexafluoropropylene, tetrafluoroethylene, and a cure site monomer.

3. The fuser system member of claim 1 wherein the amino silane comprises the general formula NH₂(CH₂)ₙNH₂(CH₂)ₘSi((OR)ₜ(R′)_{w}) wherein n and m are numbers from about 1 to about 20; a sum of t and w equals 3; and R and R′ are the same or different and are an aliphatic group of from about 1 to about 20 carbon atoms or an aromatic group of from about 6 to about 18 carbons.

4. The fuser system member of claim 1 wherein the amino silane comprises from about 0.5 weight percent to about 10 weight percent based on the weight of fluoroelastomer.

5. The fuser system member of claim 1 wherein the mercapto-functionalized oil is represented by the structure: 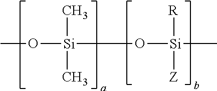
wherein R is CH₃, and alkyl group or and aryl group, Z is (CH₂)ₙSH where n is from about 1 to about 20, the ratio of a:b is from about 1:1 to about 2000:1.

6. The fuser system member of claim 1 wherein the topcoat layer further comprises a filler material selected from the group consisting of inorganic particles, carbon blacks, carbon nanotubes, tin oxide, antimony dioxide, antimony-doped tin oxide, titanium dioxide, indium oxide, zinc oxide, indium oxide, indium-doped tin trioxide, polyanilines, polythiophenes, polyacetylene, poly(p-phenylene vinylene), poly(p-phenylene sulfide), pyrroles, polyindole, polypyrene, polycarbazole, polyazulene, polyazepine, poly(fluorine), polynaphthalene, salts of organic sulfonic acid, esters of phosphoric acid, esters of fatty acids, ammonium or phosphonium salts and mixtures thereof.

7. The fuser system member of claim 1 further comprising a functional layer disposed between the substrate and the topcoat layer.

8. The fuser system member of claim 7 further wherein the functional layer comprises a material selected from the group consisting of silicone, fluorosilicone and fluorelastomer.

9. The fuser system member of claim 1 further comprising an adhesive layer disposed on the substrate.

10. A fuser system member comprising:
a substrate;
a resilient layer disposed on the substrate;
a topcoat layer disposed on the resilient layer comprising a fluoroelastomer cross-linked with amino silane wherein the topcoat layer is substantially free of copper oxide; and
a mercapto-functionalized oil disposed on the topcoat layer.

11. The fuser system member of claim 10 wherein the fluoroelastomer is a material selected form the group consisting of copolymers of two of vinylidenefluoride, hexafluoropropylene, and tetrafluoroethylene; terpolymers of vinylidenefluoride, hexafluoropropylene, and tetrafluoroethylene; and tetrapolymers of vinylidenefluoride, hexafluoropropylene, tetrafluoroethylene, and a cure site monomer.

12. The fuser system member of claim 10 wherein the amino silane comprises the general formula NH₂(CH₂)ₙNH₂(CH₂)ₘSi((OR)ₜ(R′)_{w}) wherein n and m are numbers from about 1 to about 20; a sum of t and w equals 3; and R and R′ are the same or different and are an aliphatic group of from about 1 to about 20 carbon atoms or an aromatic group of from about 6 to about 18 carbons.

13. The fuser system member of claim 10 wherein the amino silane comprises from about 0.5 weight percent to about 10 weight percent based on the weight of fluoroelastomer.

14. The fuser system member of claim 10 wherein the mercapto-functionalized oil is represented by the structure: 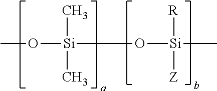
wherein R is CH₃, and alkyl group or and aryl group, Z is (CH₂)ₙSH where n is from about 1 to about 20, the ratio of a:b is from about 1:1 to about 2000:1.

15. The fuser system member of claim 10 further wherein the resilient layer comprises a material selected from the group consisting of silicone, fluorosilicone and fluorelastomer.

16. The fuser system member of claim 10 further comprising an adhesive layer disposed between the substrate and the resilient layer.

17. The fuser system member of claim 10 further comprising an adhesive layer disposed between the resilient layer and the topcoat layer.

18. An image rendering device comprising: an image applying component for applying an image to a copy substrate; and a fusing apparatus which receives the copy substrate with the applied image from the image applying component and fixes the applied image more permanently to the copy substrate, the fusing apparatus comprising a fusing member and a pressure member which define a nip therebetween for receiving the copy substrate therethrough, the fuser member comprising; a substrate; a topcoat layer disposed on the substrate comprising a fluoroelastomer cross-linked with amino silane wherein the topcoat layer is substantially free of copper oxide, wherein a mercapto-functionalized oil disposed on the topcoat layer.

19. The image rendering device of claim 18 wherein the amino silane comprises the general formula NH₂(CH₂)ₙNH₂(CH₂)ₘSi((OR)ₜ(R′)_{w}) wherein n and m are numbers from about 1 to about 20; a sum of t and w equal 3; and R and R′ are the same or different and are an aliphatic group of from about 1 to about 20 carbon atoms or an aromatic group of from about 6 to about 18 carbons.

20. The image rendering device of claim 18 wherein the mercapto-functionalized oil is represented by the structure: 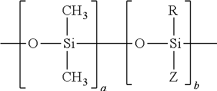
wherein R is CH₃, and alkyl group or and aryl group, Z is (CH₂)ₙSH where n is from about 1 to about 20, the ratio of a:b is from about 1:1 to about 2000:1.
